(19) United States
(12) Patent Application Publication
(10) Pub. No.: US 2024/0246496 A1
(43) Pub. Date: Jul. 25, 2024

(54) RESIN-MOLDED ARTICLE

(71) Applicant: MORIROKU TECHNOLOGY COMPANY, LTD., Tokyo (JP)

(72) Inventors: Tomohisa Ishikawa, Tokyo (JP); Takashi Tanaka, Tokyo (JP); Mitsuru Suzuki, Tokyo (JP)

(21) Appl. No.: 18/416,344

(22) Filed: Jan. 18, 2024

(30) Foreign Application Priority Data
Jan. 24, 2023 (JP) 2023-008689

(51) Int. Cl. B60R 13/04

(52) U.S. Cl. CPC B60R 13/04

(57) ABSTRACT

A resin-molded article includes a main body including a first face member including a locked portion, and a second face member raised from the first face member. A protrusion locked to the locked portion and protruding from the first face member. A pawl of the protrusion includes a first wall and a second wall disposed in a substantially V shape, and is bendable. A distal end face of the second wall is in contact with an upper face of the locked portion. The pawl is configured such that one end which is an end closer to a swing axis is bent with a weaker load than an other end which is an end farther from the swing axis.

### FIELD OF THE INVENTION

The present invention relates to a resin-molded article.

### BACKGROUND

For example, a resin-molded article that is elongated is provided at a lower portion of a door for vehicle as an exterior component. As a technique of the related art relating to such a resin-molded article, there is a technique disclosed in Japanese Patent No. 4,753,983 (JP-B-4753983).

Japanese Patent No. 4753983 discloses a resin-molded article called a splash guard that is attached to a lower portion of a side face of a vehicle body (outer peripheral face of a side sill). The resin-molded article includes a main body having an overall substantially L shape and including portions that are formed with intermittent voids, and protrusions locked to the portions of the main body, which are formed with the voids, and protruding from the main body.

Holes are formed in the protrusions, and by aligning these holes with holes formed in the vehicle body and attaching clips, the resin-molded article can be fixed to the vehicle body.

The protrusions are provided integrally with the main body to be swingable. If an attempt is made to mold the resin-molded article into a shape in which the protrusions are locked to the main body from the beginning, slide molds and the like are required, and a molding mold becomes complicated. When configuring the protrusions to be swingable, the resin-molded article can be manufactured by a simple mold.

### SUMMARY

In a resin-molded article in which protrusions are swingable with respect to a main body, after an intermediate article of the resin-molded article is taken out from the molding mold, the protrusions need to be pushed and locked to the main body to obtain a finished article of the resin-molded article. When the protrusions are locked, it is desirable to easily lock the protrusions to the main body, whereas after the protrusions are locked to the main body, it is desirable to make it difficult for the protrusions to come off.

According to the present disclosure, there is provided a resin-molded article including a main body including a first face member and a second face member raised from the first face member. A protrusion formed integrally with the first face member to be swingable, locked to a locked portion formed in the first face member, and protruding from the first face member. A portion of the protrusion locked to the locked portion is formed of a pawl in which a first wall and a second wall are disposed in a substantially V shape and which is bendable. A distal end face of the second wall is in contact with an upper face of the locked portion. The pawl extends in a direction intersecting a swing axis of the protrusion, and is configured such that one end which is an end closer to the swing axis is bent with a weaker load than an other end which is an end farther from the swing axis.

According to the disclosure, there is provided the resin-molded article that allows the protrusion to be easily locked to the main body and that makes it difficult for the protrusion to come off from the main body after being locked.

### BRIEF DESCRIPTION OF THE DRAWINGS

FIG. 1 is a perspective diagram of a resin-molded article according to an embodiment of the invention;

FIG. 2 is an enlarged diagram of a portion 2 of FIG. 1;

FIG. 3 is a diagram describing an intermediate article of the resin-molded article illustrated in FIG. 2;

FIG. 4 is a cross-sectional diagram of when a protrusion illustrated in FIG. 2 is pushed into a main body;

FIG. 5 is a perspective diagram when the protrusion illustrated in FIG. 2 is pushed into the main body as viewed from below;

FIG. 6 is a diagram viewed in the direction of arrow 6 in FIG. 2; and

FIG. 7 is a diagram viewed in the direction of arrow 7 in FIG. 2.

### DETAILED DESCRIPTION

An embodiment of the invention will be described below with reference to the accompanying drawings. Hereinafter, a description will be given based on an example in which a resin-molded article is used as an exterior component for vehicle. In the description, left-right indicates left-right with reference to an occupant of a vehicle, and front-rear indicates front-rear with reference to a traveling direction of the vehicle. In addition, in the drawings, Fr represents the front with reference to the vehicle, Rr represents the rear, Le represents the left when viewed from the occupant of the vehicle, Ri represents the right when viewed from the occupant, Up represents the top or up, and Dn represents the bottom or down. A form illustrated in the accompanying drawings is one example, and the invention is not limited to the form.

### Embodiment

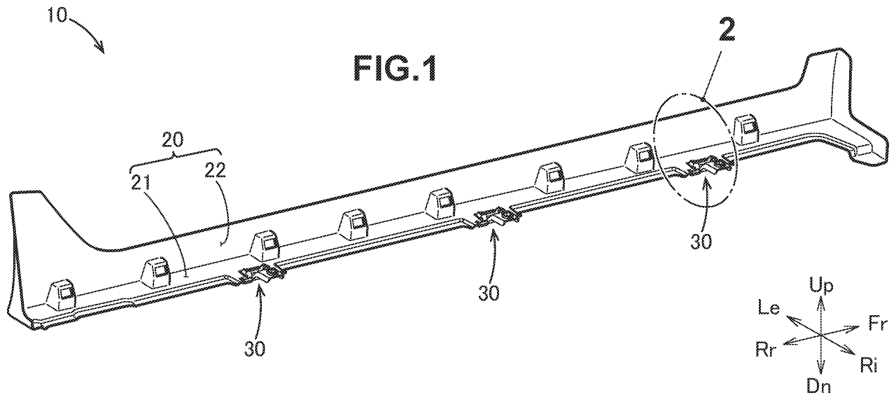

Referring to FIG. 1, a resin-molded article 10 is an exterior component attached to an outer face of a side sill forming a lower portion of a vehicle body. The resin-molded article 10 is formed, for example, by injection molding, and is fixed to the side sill via clips.

The resin-molded article 10 includes a main body 20 that is elongated and that has a substantially L shape, and a plurality of protrusions 30 formed integrally with the main body 20 and locked to the main body 20. The protrusions 30 are portions for attaching clips.

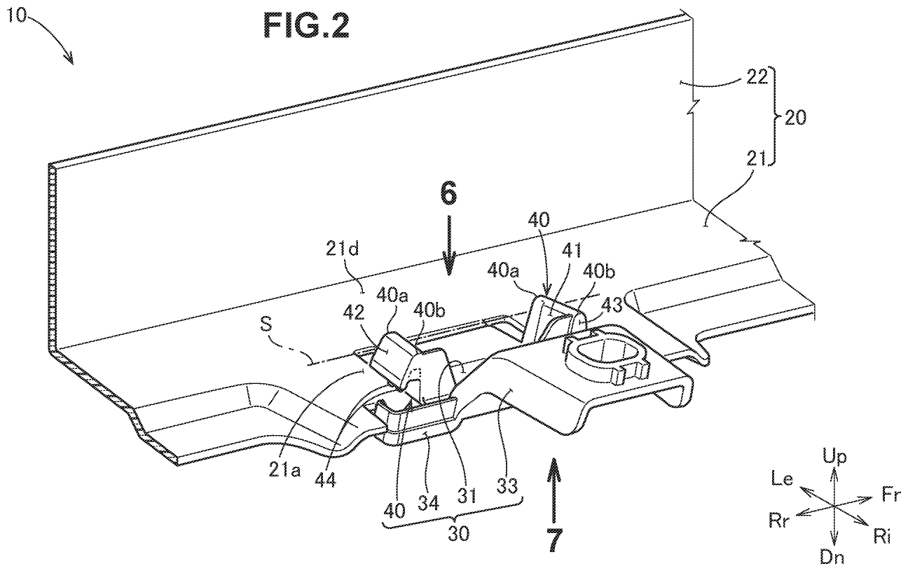

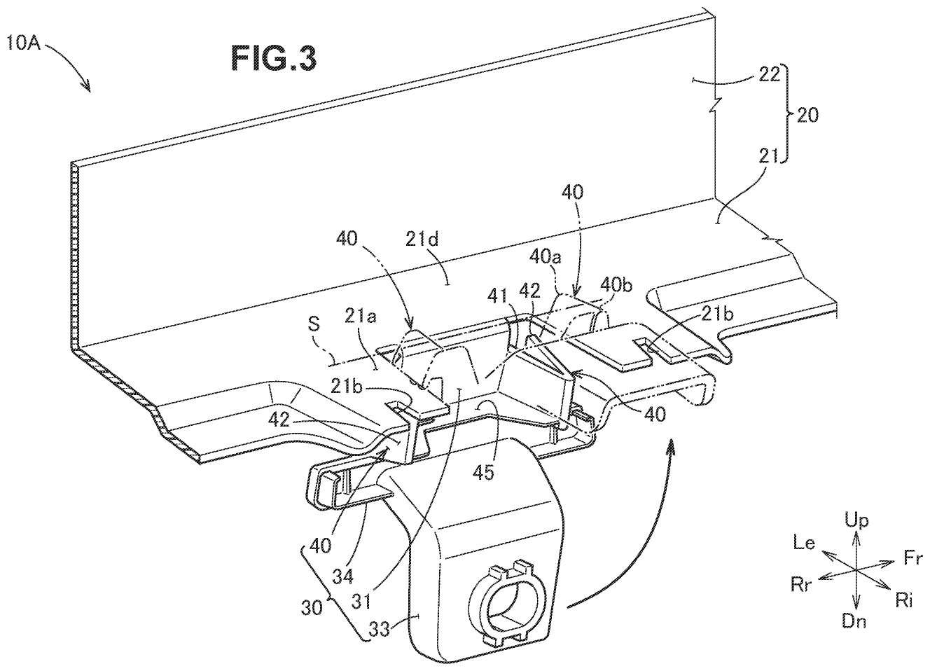

Referring to FIGS. 2 and 3, the resin-molded article 10 is manufactured by forming an intermediate article 10A illustrated in FIG. 3 using injection molding, and by swinging and pushing the protrusions 30 toward the main body 20. In a case where an attempt is made to mold the resin-molded article 10 into a shape illustrated in FIG. 2 through injection molding, a plurality of slide molds and the like are required, thereby making a molding mold expensive. By forming the intermediate article 10A as illustrated in FIG. 3 and adopting a configuration in which the protrusions 30 are pushed into the main body 20, the resin-molded article 10 can be manufactured using an inexpensive molding mold.

The main body 20 includes a first face member 21 that is formed with partial voids, and a second face member 22 raised from the first face member 21.

The main body 20 may include a third face member extending from an upper end of the second face member 22 to face the first face member 21. Namely, the shape of the main body 20 is not limited to a substantially L shape; however, any shape such as a substantially U shape, a substantially J shape, or a substantially T shape can be adopted.

In the first face member 21, locked portions 21a to which the protrusions 30 are locked and main body-side positioners 21b and 21b for positioning the protrusions 30 when the protrusions 30 are pushed thereinto are formed.

Each locked portion 21a is formed to surround a substantially U-shaped portion that opens toward the center of a vehicle width.

The main body-side positioners 21b and 21b are slit-shaped portions formed to interpose the locked portion 21a therebetween. The two main body-side positioners 21b and 21b are not necessarily required. In addition, the shape of the main body-side positioners 21b and 21b may be a shape other than a slit, for example, a round hole shape, a rectangular hole shape, or the like as long as the protrusion 30 partially penetrates therethrough.

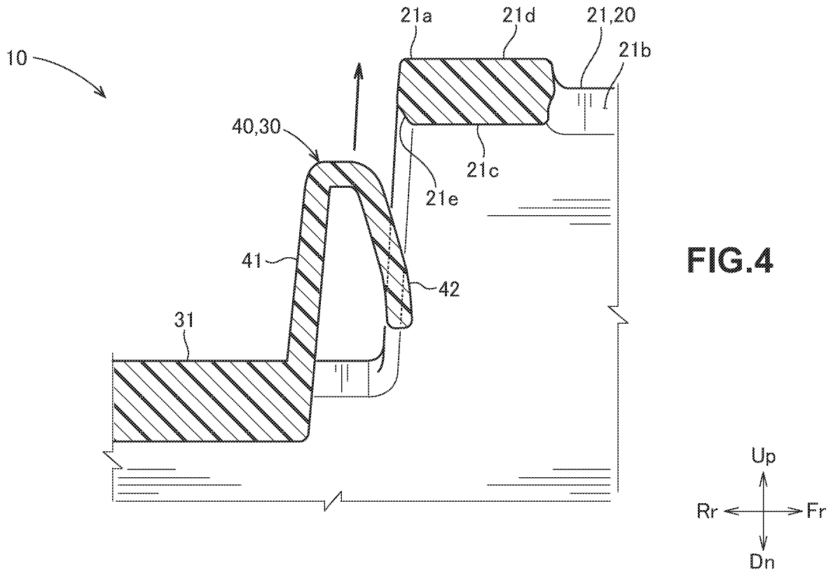

Referring to FIG. 4, the locked portion 21a includes a guide 21e that is obliquely formed from a lower face 21c toward an upper face 21d with respect to a direction in which the protrusion 30 is pushed, to serve as a guide when the protrusion 30 is locked.

Referring to FIGS. 2 and 3, the protrusion 30 is formed to be swingable around a swing axis S. The protrusion 30 is locked to the locked portion 21a, and protrudes in the same direction as a direction in which the second face member 22 is raised (upward in FIG. 2).

The swing axis S extends substantially in a front-rear direction to pass through the boundary between the first face member 21 and the protrusion 30. For example, the boundary is formed to be thinner than the first face member 21 or the protrusion 30.

In addition, a direction in which the protrusions 30 protrude from the first face member 21 does not need to completely coincide with the direction in which the second face member 22 is raised. For example, since the protrusions 30 and the second face member are raised upward from the first face member 21, it is difficult to manufacture the resin-molded article 10 through one injection molding, and the protrusions 30 and the second face member may be raised in the same direction to the extent that the resin-molded article 10 can be easily manufactured through the intermediate article 10A. For this reason, the “same direction” referred to here may also include a case where the protrusions 30 protrude to be obliquely inclined with respect to the first face member 21.

The protrusion 30 includes a base 31 extending from the boundary between the protrusion 30 and the first face member 21 (from the swing axis S); pawls 40 and 40 formed at the front and rear of the base 31, respectively, to interpose the base 31 therebetween and locked to the locked portion 21a; a clip attachment 33 which extends from the base 31 toward the center of the vehicle width and upward and to which a clip can be attached; and protrusion-side positioners 34 and 34 extending forward and rearward from the clip attachment 33 and penetrating through the main body-side positioners 21b and 21b.

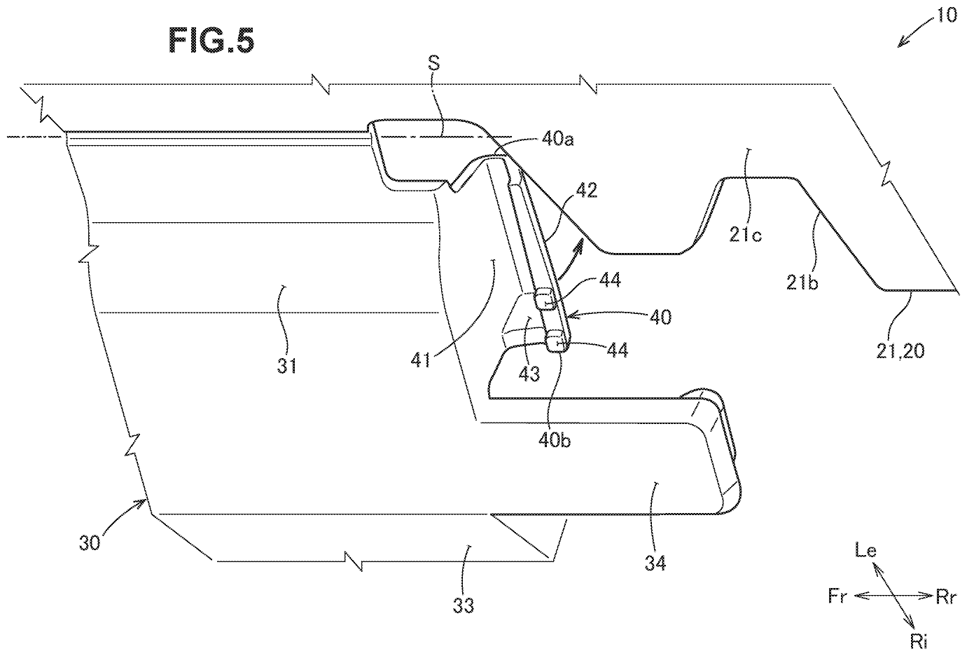

Referring to FIGS. 4 and 5, the pawl 40 is formed in a substantially V shape. The pawl 40 includes a first wall 41 raised from the base 31, and a second wall 42 extending from a distal end of the first wall 41. The pawl 40 extends obliquely with respect to the swing axis S. An extension line of the pawl 40 intersects the swing axis S when the protrusion 30 locked to the locked portion 21a is viewed from above.

An end of the pawl 40 closer to the swing axis S is referred to as one end 40a, and an end of the pawl 40 farther from the swing axis S is referred to as an other end 40b. In the pawl 40, the one end 40a bends more easily than the other end 40b. Namely, in the pawl 40, the one end 40a is bent with a weaker load than the other end 40b. The pawl 40 has a plurality of configurations for allowing the one end 40a to bend more easily than the other end 40b. The resin-molded article 10 needs to have at least one configuration for allowing the one end 40a to bend more easily than the other end 40b.

In addition, a first rib 43 connecting from the first wall 41 to the second wall 42 is formed on an other end 40b side of the pawl 40. The first rib 43 is formed up to the bottom of the V shape. Two projections 44 and 44 protruding toward the locked portion 21a are formed on a distal end face on the other end 40b side of the second wall 42.

The first rib 43 connecting from the first wall 41 to the second wall 42 is not formed on one end 40a side. Accordingly, the one end 40a side can be bent with a weaker load than the other end 40b.

In addition, the projections 44 are not essential elements, and the distal end face on the other end 40b side of the second wall 42 may be brought into direct contact with the locked portion 21a. In addition, the position, number, size, and the like of the projections 44 are also optional.

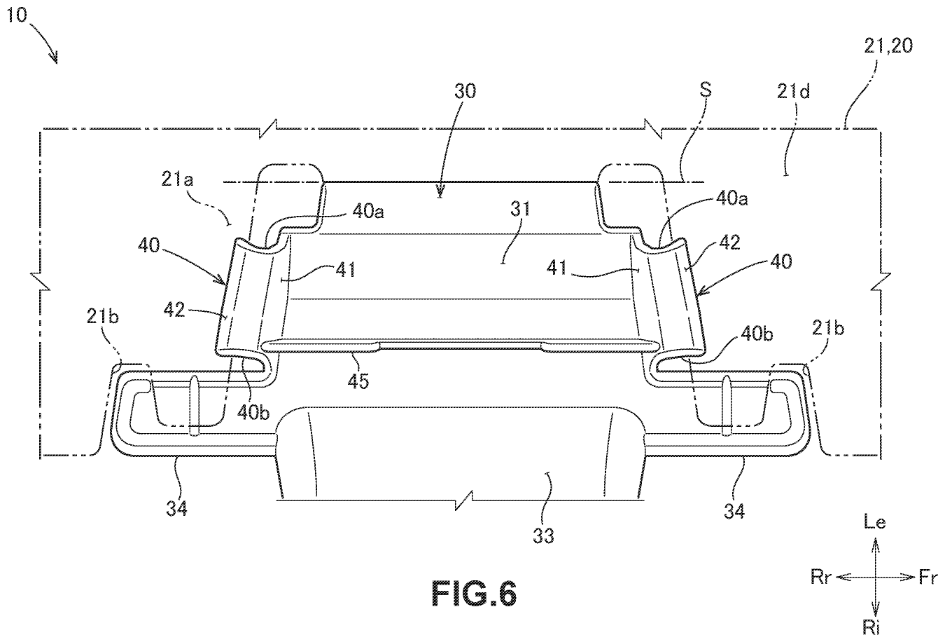

Referring to FIG. 6, a second rib 45 extending from the first walls 41 and 41 in a direction away from the second walls 42 and 42 is formed at the other ends 40b and 40b of the pawls 40 and 40. The second rib 45 is formed to connect the two first walls 41 and 41. In the second rib 45, portions connected to the first walls 41 and 41 are formed high, and a central portion connecting the portions is formed low.

The second rib 45 is not formed on the one end 40a side. Accordingly, the one end 40a side can be bent with a weaker load than the other end 40b.

In addition, the second rib 45 may not include the central portion, and the shape and the like are optional.

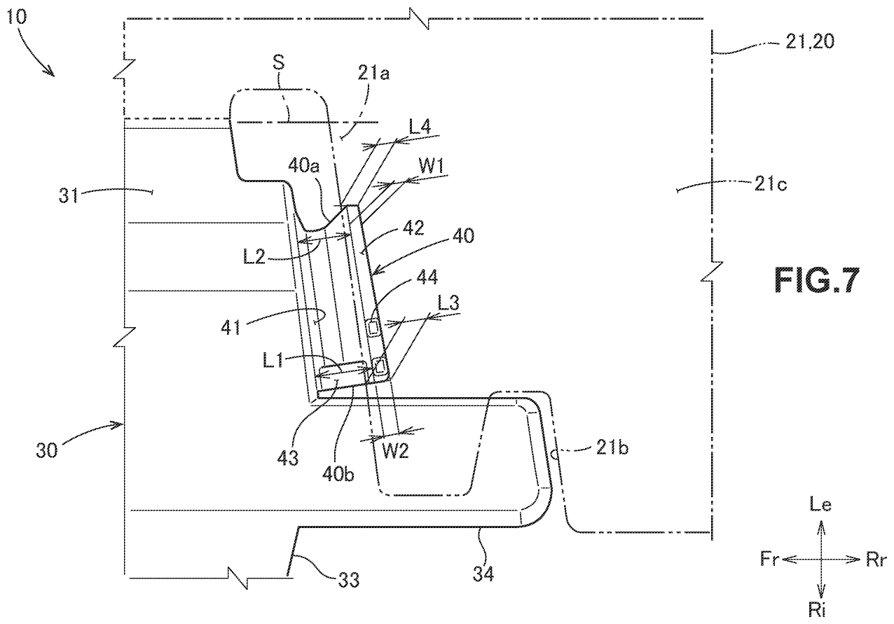

Referring to FIG. 7, in the distal end face of the second wall 42, a width W1 of the one end 40a is smaller than a width W2 of the other end 40b. Namely, the width of the distal end face of the second wall 42 increases from the one end 40a toward the other end 40b. Since the one end 40a is formed to be thinner than the other end 40b, the one end 40a is bent with a weaker load than the other end 40b.

In addition, a distance L1 from the first wall 41 to the distal end face of the second wall 42 at the other end 40b is longer than a distance L2 from the first wall 41 to the distal end face of the second wall 42 at the one end 40a. In addition, a distance L3 from an edge of the locked portion 21a to an outer face distal end of the second wall 42 at the other end 40b is longer than a distance L4 from the edge of the locked portion 21a to the outer face distal end of the second wall 42 at the one end 40a.

Accordingly, the one end 40a side can be pushed into the main body 20 with a weaker force than the other end 40b side.

Referring to FIG. 2, a substantially elliptical hole is formed at the center of the clip attachment 33. By aligning this hole with a hole formed in the side sill and penetrating a clip therethrough, the resin-molded article 10 can be fixed to the side sill.

The resin-molded article 10 described above is summarized as follows.

Referring to FIGS. 2 and 3, according to a first aspect, the resin-molded article 10 includes the main body 20 including the first face member 21 and the second face member 22 raised from the first face member 21; and the protrusion 30 formed integrally with the first face member 21 to be swingable, locked to the locked portion 21a formed in the first face member 21, and protruding from the first face member 21.

Referring to FIGS. 5 and 7, the portion of the protrusion 30 locked to the locked portion 21a is formed of the pawl 40 in which the first wall 41 and the second wall 42 are disposed in a substantially V shape and which is bendable. A distal end face of the second wall 42 is in contact with the upper face 21d of the locked portion 21a. The pawl 40 extends in a direction intersecting the swing axis S of the protrusion 30, and is configured such that one end 40a which is the end closer to the swing axis S is bent with a weaker load than the other end 40b which is an end farther from the swing axis S.

Since the pawl 40 can be easily bent at the one end 40a closer to the swing axis S, the protrusion 30 can be pushed into the main body 20 with a small force at the beginning of pushing the protrusion 30. Since the force required at the parts where pushing begins is small, the force required for pushing is small as a whole. On the other hand, when the protrusion 30 is removed from the locked portion 21a, it is necessary to bend an other end 40b side farthest from the swing axis S. Since a large force is required to bend the other end 40b side, it is difficult to remove the protrusion 30 from the main body 20 after being locked. In other words, after the resin-molded article 10 is attached, the resin-molded article 10 can be prevented from unintentionally coming off. It is possible to provide the resin-molded article 10 that allows the protrusion 30 to be easily locked to the main body 20 and that makes it difficult for the protrusion 30 to come off from the main body 20 after being locked.

According to a second aspect, in the resin-molded article 10 according to the first aspect, the first rib 43 connecting from the first wall 41 to the second wall 42 is formed only at the other end 40b. The force required to bend the other end 40b can be increased, and the strength of the pawl 40 can be enhanced.

Referring to FIG. 6, according to a third aspect, in the resin-molded article 10 according to the first or second aspect, the second rib 45 extending from the first wall 41 in a direction away from the second wall 42 is formed only at the other end 40b. The force required to bend the other end 40b can be increased, and the strength of the pawl 40 can be enhanced.

Referring to FIG. 7, according to a fourth aspect, in the resin-molded article 10 according to any one of the first to third aspects, a width of the distal end face of the second wall 42 increases from the one end 40a toward the other end 40b. Accordingly, the one end 40a is configured to be bent with a weaker load than the other end 40b. By adjusting the size of the width, the force required for bending can be more finely adjusted.

Referring to FIG. 4, according to a fifth aspect, in the resin-molded article 10 according to any one of the first to fourth aspects, the locked portion 21a includes the guide 21e that is obliquely formed from the lower face 21c toward the upper face 21d with respect to a direction in which the pawl 40 is pushed, to serve as a guide when the pawl 40 is locked. The protrusion 30 can be more easily locked.

Referring to FIG. 7, according to a sixth aspect, in the resin-molded article 10 according to any one of the first to fifth aspects, the distance L1 from the first wall 41 to the distal end face of the second wall 42 at the other end 40b is longer than the distance L2 from the first wall 41 to the distal end face of the second wall 42 at the one end 40a. By increasing the distance from the first wall 41 to the second wall 42 at the other end 40b, it is possible to more reliably prevent the protrusion 30 from unintentionally coming off.

According to a seventh aspect, in the resin-molded article 10 according to any one of the first to sixth aspects, the distance L3 from an edge of the locked portion 21a to an outer face distal end of the second wall 42 at the other end 40b is longer than the distance L4 from the edge of the locked portion 21a to the outer face distal end of the second wall 42 at the one end 40a. By ensuring a long distance from the edge of the locked portion 21a to the other end 40b, it is possible to more reliably prevent the protrusion 30 from unintentionally coming off.

An example in which the resin-molded article according to the invention is an elongated splash guard that is fixed to a side sill has been described; however, the resin-molded article can also be applied to other portions. In addition, the resin-molded article is not limited to an exterior component for vehicle, and can also be used as an interior component for vehicle or in applications other than vehicles, and the invention is not limited to these types. The invention is not limited to the embodiment as long as the actions and effects of the invention are achieved.

What is claimed is:

1. A resin-molded article comprising:
a main body including a first face member and a second face member raised from the first face member; and
a protrusion formed integrally with the first face member to be swingable, locked to a locked portion formed in the first face member, and protruding from the first face member,
wherein a portion of the protrusion locked to the locked portion is formed of a pawl in which a first wall and a second wall are disposed in a substantially V shape and which is bendable,
a distal end face of the second wall is in contact with an upper face of the locked portion, and
the pawl extends in a direction intersecting a swing axis of the protrusion, and is configured such that one end which is an end closer to the swing axis is bent with a weaker load than an other end which is an end farther from the swing axis.

2. The resin-molded article according to claim 1,
wherein a first rib connecting from the first wall to the second wall is formed at the other end.

3. The resin-molded article according to claim 1,
wherein a second rib extending from the first wall in a direction away from the second wall is formed at the other end.

4. The resin-molded article according to claim 1,
wherein a width of the distal end face of the second wall increases from the one end toward the other end.

5. The resin-molded article according to claim 1,
wherein the locked portion includes a guide that is obliquely formed from a lower face which is a face on a back side of the upper face toward the upper face with respect to a direction in which the pawl is pushed, to serve as a guide when the pawl is locked.

6. The resin-molded article according to claim 1,
wherein a distance from the first wall to the distal end face of the second wall at the other end is longer than a distance from the first wall to the distal end face of the second wall at the one end.

7. The resin-molded article according to claim 1,
wherein a distance from an edge of the locked portion to an outer face distal end of the second wall at the other end is longer than a distance from the edge of the locked portion to the outer face distal end of the second wall at the one end.
